(19) United States
(12) Patent Application Publication
(10) Pub. No.: US 2019/0074900 A1
(43) Pub. Date: Mar. 7, 2019

(54) OPTICAL TRANSMISSION METHOD AND DEVICE FOR BANKING TRANSACTION

(71) Applicant: ORANGE, Paris (FR)

(72) Inventors: Olivier Bouchet, Chatillon Cedex (FR); Micheline Perrufel, Chatillon Cedex (FR); Christophe Cutullic, Chatillon Cedex (FR); Philippe Dussaume, Chatillon Cedex (FR)

(21) Appl. No.: 16/116,349

(22) Filed: Aug. 29, 2018

(30) Foreign Application Priority Data
Sep. 5, 2017 (FR) 1758160

(51) Int. Cl. H04B 10/114; G08C 23/04

(52) U.S. Cl. CPC H04B 10/114; G08C 23/04

(57) ABSTRACT

The present invention relates to an optical coupling device (COU) between two telecommunication terminals (TM1, TM2) each provided with an optical transmitter and receiver. The device comprises:
an optical tunnel (TUN),
a first contact surface (IF1) intended to accommodate a terminal and to ensure the optical coupling between the optical tunnel and on the one hand the optical transmitter and on the other the optical receiver of this terminal,
a second contact surface (IF2) intended to ensure the optical coupling between the optical tunnel and on the one hand the optical transmitter and on the other the optical receiver of the other terminal.

The present invention relates to the field of data transmissions via an optical flow.

### PRIOR ART

A number of communication terminals used for banking transactions are known. Banking transactions may be performed remotely, e.g. on e-commerce sites, they may be performed locally via a dedicated payment terminal referred to as an EPT and for some years they have been able to be performed via a mobile phone.

Various technologies are implemented in these transactions: wired link with reading a bank card and entering a confidential code, NFC (Near Field Communication) type very short range radio link, etc.

Many customers are reluctant to make a payment via an NFC type very short range radio transmission because they have doubts about the security associated with this type of transmission. In addition, some customers are fighting against the deployment of systems using radio waves for reasons of sensitivity to these waves.

EPT terminals are very widespread and generally recognized as safe by customers but they have a cost sometimes regarded as prohibitive by the merchant.

Main Features of the Invention

The present invention provides a low-cost architecture for performing a completely secure local banking transaction via an optical transmission.

To this end, an object of the invention is a method for transmitting data between two telecommunication terminals including at least one of mobile type via an optical channel between the optical transmitters and receivers of the two terminals, comprising:
the optical coupling of just the two telecommunication terminals to one another by means of an optical tunnel.

According to one embodiment, the optical transmitter and the optical receiver of the at least one mobile telecommunication terminal are a light-emitting diode and a camera respectively.

The invention has a further object of an optical coupling device between two telecommunication terminals including at least one of mobile type, each of the two terminals being provided with an optical transmitter and receiver, the device comprising:
an optical tunnel,
a first contact surface intended to accommodate the at least one mobile telecommunication terminal and to ensure the optical coupling between the optical tunnel and on the one hand the optical transmitter and on the other the optical receiver of this terminal,
a second contact surface intended to ensure the optical coupling between the optical tunnel and on the one hand the optical transmitter and on the other the optical receiver of the other telecommunication terminal.

According to one embodiment of the coupling device, the second contact surface is intended to be placed on this other telecommunication terminal.

According to one embodiment of the coupling device, the second contact surface is intended to accommodate this other telecommunication terminal.

According to one embodiment of the coupling device, the optical tunnel comprises a bundle of cross-connected optical fibres between the first contact surface and the second contact surface.

According to one embodiment of the coupling device, the optical tunnel comprises an optical-to-electrical converter and an electrical-to-optical converter.

The optical tunnel ensures the optical coupling without generating a dedicated electromagnetic flow and without any electrical consumption. The invention thus allows a very simple, inexpensive coupling between an optical source of a first optical telecommunication terminal and the optical receiver of a second optical telecommunication terminal.

The terminals are each provided with an optical source and receiver. The optical coupling is therefore bidirectional in a peer-to-peer communication mode between the two terminals.

At least one of the two terminals is a mobile terminal that generally belongs to the customer. The second terminal may equally well be mobile or fixed; it generally belongs to the merchant in a banking transaction context.

The wavelength of the optical flow may belong to the visible domain which allows both the customer and the merchant to ascertain the absence of broadcasting of the optical flow outside the coupling device and thus to reassure them about the security of the transmission between the two terminals.

The coupling device channels the optical flow in the optical tunnel. The coupling device makes it possible to establish an optical communication with a medium allowing the physical blocking of any broadcasting of the optical flows transmitted and received by the optical source and receiver (e.g. camera and LED of a smartphone, a tablet or a laptop) to the outside. The invention thus provides a simple solution for transmitting data between the two terminals by performing a secure two-way wireless optical communication.

The method may be used for performing a financial transaction between the identified bearers of the respective telecommunication terminals.

The invention thus provides a simple and inexpensive alternative to transactions via a conventional bank payment terminal.

### LIST OF FIGURES

Other features and advantages of the invention will become apparent in the following description made with reference to the appended figures given by way of non-restrictive example.

FIGS. 1a and 1b are diagrams of a first embodiment of a coupling device according to the invention between a smartphone and a tablet.

FIGS. 2a and 2b are diagrams of a second embodiment of a coupling device according to the invention between a smartphone and a tablet.

FIG. 3 is a diagram of an embodiment of a coupling device with optical fibre cross-connection making it possible to modify the linearity of the optical flow transmission.

### DESCRIPTION OF PARTICULAR EMBODIMENTS OF THE INVENTION

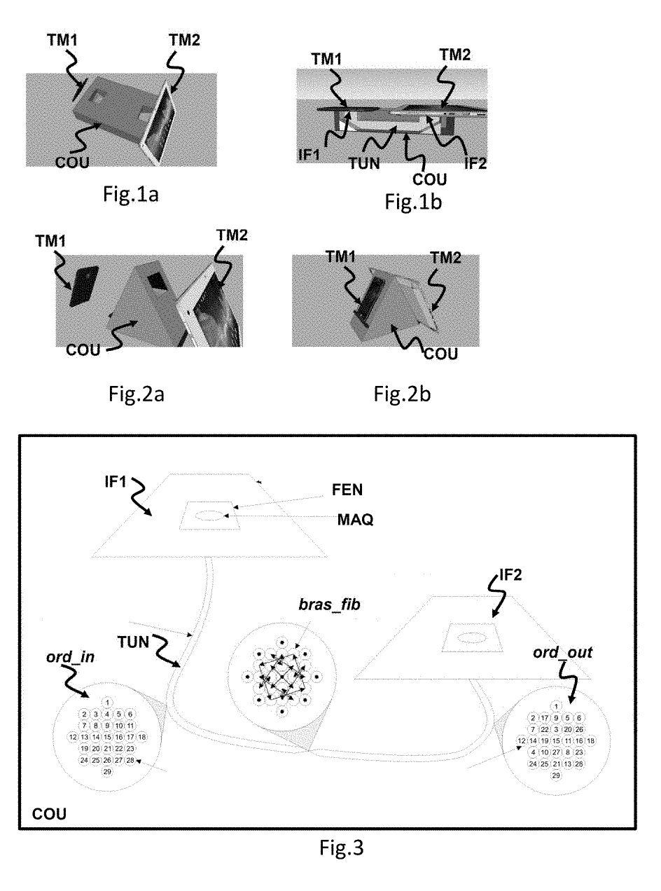

FIGS. 1a and 1b are diagrams of a first embodiment of a coupling device according to the invention between two mobile telecommunication terminals, a smartphone and a tablet.

With reference to FIGS. 1a and 1b, the coupling device COU between a smartphone TM1 and a tablet TM2 comprises an optical tunnel TUN, a first contact surface IF1 and a second contact surface IF2.

The first contact surface IF1 is intended to accommodate the smartphone TM1. On the one hand it ensures the optical coupling between the optical tunnel TUN and the optical transmitter of the smartphone TM1 and on the other hand it ensures the optical coupling between the optical tunnel TUN and the optical receiver of this smartphone TM1.

The second contact surface IF2 is intended to accommodate the tablet TM2. On the one hand it ensures the optical coupling between the optical tunnel TUN and the optical transmitter of the tablet TM2 and on the other hand it ensures the optical coupling between the optical tunnel TUN and the optical receiver of this tablet TM2.

The optical transmitter of the smartphone TM1 is, for example, an LED and its optical receiver a CCD (abbreviation for Charge Coupled Device) camera. The tablet is, for example, similarly provided with an LED and a CCD camera.

A CCD camera converts a light signal into an electrical signal. Such a camera comprises a CCD matrix formed of rows and columns defining pixels, each of which corresponds to a semiconductor element sandwiched in an electrical capacitor. The principle of reading a CCD matrix involves defining the terminals of the columns by a p-doping etched in the silicon. On the other hand, the terminals of the rows are defined by a controlled polarization. The potential well that is a pixel is static in the phase of acquisition of the scientific signal then variable during the reading of the pixels.

In operation, an incident photon (received flow) creates a photoelectron when it brings to an electron of the semiconductor material the energy necessary for crossing the energy threshold (gap). The photoelectrons are stored in the potential well that is the suitably polarized pixel. Reading these photoelectrons is controlled by polarization via field effect transistors. It takes place either directly, a shutter concealing the source, or by frame transfer. In the latter case, one half of the surface of the CCD matrix is reserved for collecting the signal; the other half is never lit but collects the photoelectrons of the receiving part before the complete reading and the transfer of the charges to the amplifying stage.

A light-emitting diode LED is an optoelectronic device capable of emitting light (emitted flow) when it is traversed by an electric current. An LED allows the electric current to pass only in one direction (the “on” direction, like a conventional diode, the reverse being the “off” direction) and produces a monochromatic or polychromatic non-coherent radiation from the conversion of electrical energy when a current passes through it. A software application is known for controlling the LED and generating flashes. Software applications are further known for generating a luminous flow and being used by a smartphone as a light.

According to the illustrated embodiment, the coupling device has a parallelepiped shape.

FIGS. 2a and 2b are diagrams of a second embodiment of a coupling device according to the invention between a smartphone and a tablet. According to the illustrated embodiment, the coupling device has a trapezoidal shape.

According to a particular embodiment, the optical tunnel comprises an inner surface in the form of a special layer limiting reflections (e.g. an absorbent structure or a Bragg grating). A reflection occurs when the (light) wave meets a surface the dimensions of which are large compared to the wavelength. The reflection characteristics of any surface depend on multiple factors:
the surface of the material (smooth or rough);
the wavelength of the incident radiation;
the angle of incidence.

The roughness of the surface of a structure in comparison with the wavelength of the incident signal constitutes an important parameter for the shape of the reflection diagram. A smooth surface reflects the incident radiation in a single direction like a mirror and Descartes' law is applied; the reflection is called specular reflection. In contrast to a radio channel for which the reflections on the surfaces are predominantly of the specular type, the dominant reflections in the field of optics are of the diffuse type.

In the case of a rough surface, the incident radiation is reflected in all directions. A surface is considered as rough, according to the Rayleigh criterion, if the following relationship is satisfied:

$$ς > \frac{λ}{8 sin {θ}_{i}}$$

$$where \text{:}$$

$$\text{-} ς is the maximum height of the irregularities of the surface ;$$

$$\text{-} λ is the wavelength of the incident radiation ;$$

$$\text{-} {θ}_{i} is the angle of incidence .$$

For an optical radiation of wavelength 1 550 nm, 850 nm or 550 nm under normal incidence, a surface is termed rough if the maximum height of the irregularities ç is greater than 0.19 μm, 0.11 μm or 0.07 μm respectively.

These values indicate that most surfaces encountered inside buildings must be regarded as rough to optical radiation. In this case, the reflection diagram exhibits a significant diffuse component; the reflected wave is diffused in multiple directions. This reflection is known as diffuse reflection.

In order to integrate this parameter, two models are commonly used for representing the reflection of the optical radiation: Lambert's model and Phong's model.

Most surfaces are very irregular and reflect optical radiation in all directions, regardless of the incident radiation. Such surfaces are termed diffuse and may be represented by Lambert's model. This model is simple and easy to implement in the context of a software development and it is described by the following equation:

$$R ( {θ}_{0} ) = ρ {R}_{i} \frac{1}{π} cos ( {θ}_{0} )$$

$$where \text{:}$$

$$\text{-} ρ is the reflection coefficient of the surface ;$$

$$\text{-} {R}_{i} is the incident optical power ;$$

$$\text{-} {θ}_{0} is the angle of observation .$$

The table in Appendix A provides an example of reflection coefficient values of an infrared beam originating from the surface of various materials.

The inner surface of the optical tunnel may thus be composed of a plastic material.

According to a particular embodiment, an optical-to-electrical converter and an electrical-to-optical converter are inserted in the optical tunnel. They potentially increase the binary data capacity per unit of time in a manner equivalent to an optical QR code.

FIG. 3 is a diagram of an embodiment of a coupling device COU with optical fibre cross-connection bras_fib. According to this embodiment, the optical tunnel TUN comprises a bundle of cross-connected optical fibres between the first contact surface IF1 and the second contact surface IF2. The cross-connection transforms the order ord_in of the fibres according to an input matrix before cross-connection into another order ord_out according to an output matrix. Altering the order by crossing the fibres in the optical tunnel alters the linearity of the transmission of the optical flow between the two contact surfaces and allows the optical power to be equally distributed.

The first contact surface IF1 comprises a support for accommodating the smartphone. This support, e.g. made of plastic, comprises a transparent window FEN above the optical tunnel. The surface comprises reference marks MAQ for positioning the smartphone so that the LED and the CCD camera are opposite the window. The second contact surface IF2 comprises a support for accommodating the tablet. This support comprises a transparent window above the optical tunnel. The surface comprises reference marks for positioning the tablet so that the LED and the CCD camera are opposite the window.

According to a particular embodiment, the optical concentration power is increased with the addition in the optical tunnel of a hemisphere or a network of microlenses.

When the holder of the smartphone TM1 wants to make a bank payment e.g. in a shop provided with the coupling device COU, they activate a bank payment application on their smartphone. This application optionally invites them to enter an identifier and a confidential code. The holder places their smartphone on the coupling device. The merchant activates their bank payment application associated with the tablet and the coupling device to establish communication with the smartphone via the coupling device.

On the merchant side, the banking application transmits the data to the smartphone by controlling the LED of the tablet and receives the data transmitted by the smartphone by controlling the CCD camera of the tablet. The banking application hosted on the smartphone controls the CCD camera and the LED of the smartphone to establish communication with the tablet by transmitting data to the tablet and by receiving data transmitted by the tablet.

APPENDIX A

| Material | Reflection Coefficient |
|---|---|
| Paint | 0.184 |
| Wallpaper | 0.184 |
| Wooden floor | 0.128 |
| Chestnut shelf | 0.0884 |
| Transparent glass | 0.0625 |
| White ceramic | 0.0517 |
| Plastic | 0.1018 |

1. Method for transmitting data between two telecommunication terminals (TM1, TM2) including at least one of mobile type via an optical channel between the optical transmitters and receivers of the two terminals, comprising:
an optical coupling of just the two telecommunication terminals to one another by means of an optical tunnel (TUN).

2. Method according to claim 1, according to which the optical transmitter and receiver of the at least one mobile telecommunication terminal (TM1) are a light-emitting diode and a camera respectively.

3. Optical coupling device (COU) between two telecommunication terminals including at least one (TM1) of mobile type each provided with an optical transmitter and an optical receiver, comprising:
an optical tunnel (TUN),
a first contact surface (IF1) intended to accommodate the at least one mobile telecommunication terminal and to ensure the optical coupling between the optical tunnel and on the one hand the optical transmitter and on the other the optical receiver of this terminal,
a second contact surface (IF2) intended to ensure the optical coupling between the optical tunnel and on the one hand the optical transmitter and on the other the optical receiver of the other telecommunication terminal.

4. Optical coupling device (COU) according to the claim 3, wherein the second contact surface is intended to be placed on this other telecommunication terminal.

5. Optical coupling device (COU) according to claim 3, wherein the second contact surface is intended to accommodate this other telecommunication terminal.

6. Optical coupling device (COU) according to claim 3, wherein the optical tunnel comprises a bundle of cross-connected optical fibres between the first contact surface and the second contact surface.

7. Optical coupling device (COU) according to claim 3, wherein the optical tunnel comprises a reflection limiting surface treatment on its inner surface.

8. Optical coupling device (COU) according to claim 3, wherein the optical tunnel comprises an optical-to-electrical converter and an electrical-to-optical converter.

9. Use of a method according to claim 1 for performing a financial transaction between the identified bearers of the respective telecommunication terminals.

10. Use of a method according to claim 2 for performing a financial transaction between the identified bearers of the respective telecommunication terminals.
